(19) United States
(12) Patent Application Publication
(10) Pub. No.: US 2011/0143877 A1
(43) Pub. Date: Jun. 16, 2011

(54) Differential gear for remote control toy car

(76) Inventor: Hsueh-Jung Lu, Lu Chu (TW)

(21) Appl. No.: 12/003,959

(22) Filed: Jan. 3, 2008

(51) Int. Cl. F16H 13/08

(52) U.S. Cl. 475/184

(57) ABSTRACT

A differential device includes a drive gear, which has a gear wheel with a center axle hole and multiple needle rollers radially mounted in the gear wheel, a first coupling device, which has an abutment wall abutted against the needle rollers at one side and a stub axle inserted through the center axle hole of the gear wheel and a coupling tube for coupling to a first external wheel, and a second coupling device, which has an abutment wall abutted against the needle rollers at an opposite side and rotatably coupled to the stub axle of the first coupling device and a coupling tube for coupling to a second external wheel.

### BACKGROUND OF THE INVENTION

1. Field of the Invention

The present invention relates to remote control toy cars and more specifically, to a differential for remote control toy car that has advantages of high durability and more particularly, cost-effectiveness and high transmission stability.

2. Description of the Related Art

For the advantages of being highly controllable and having much fun, remote control toy cars are highly appreciated by children as well as adults. It is commonly seen that people are using remote control toy cars to play games in parks or sports fields. Regular remote control toy cars commonly use a differential gear to control the speed of the inner wheels and the speed of the outer wheels when making a turn. The differential gear of a remote control toy car is a miniature model of the internal structure of a real car. A differential gear of this kind of design is not practical in actual application. Because there is a great different in dimension between a remote control toy car and a real car of the same model, a remote control toy car of which the differential gear is a miniature design of the differential gear of a real car of the same model may overturn in curve driving due to idle running of the wheels. Further, the manufacturing of a differential gear for remote control toy car made by scaling down the size of a differential gear for real car is expensive. A miniature differential gear of this design has the drawback of complicated structure and installation procedure. Further, a miniature differential gear of this design is easy to break, not durable in use.

Therefore, it is desirable to provide a cost-effective, highly durable and highly reliable differential gear for remote control scientific, educational and racing toys.

### SUMMARY OF THE INVENTION

The present invention has been accomplished under the circumstances in view. It is the main object of the present invention to provide a differential gear for remote control toy car that has the advantages of cost-effectiveness, high durability and high transmission reliability.

To achieve this and other objects of the present invention, the differential gear for remote control toy car comprises a drive gear, a first coupling device, and a second coupling device. The drive gear comprises a gear wheel that has a center axle hole, and a plurality of needle rollers radially mounted in the gear wheel. The first coupling device comprises an abutment wall stopped against the needle rollers and disposed at one side relative to the gear wheel, a stub axle perpendicularly extending from the center of one side of the abutment wall of the first coupling device and inserted through the center axle hole of the gear wheel, and a coupling tube perpendicularly extending from the center of the other side of the abutment wall of the first coupling device. The second coupling device comprises an abutment wall stopped against the needle rollers and disposed at an opposite side relative to the gear wheel, a recessed coupling hole formed on one side of the abutment wall of the second coupling device and coupled to the stub axle of the first coupling device for allowing free rotation of the second coupling device relative to the first ,coupling device, and a coupling tube perpendicularly extending from the center of the other side of the abutment wall of the second coupling device.

### BRIEF DESCRIPTION OF THE DRAWINGS

FIG. 1 is an oblique elevation of a differential gear for remote control toy car in accordance with the present invention.

FIG. 2 is another oblique elevation of the differential gear for remote control toy car according to the present invention when viewed from another angle.

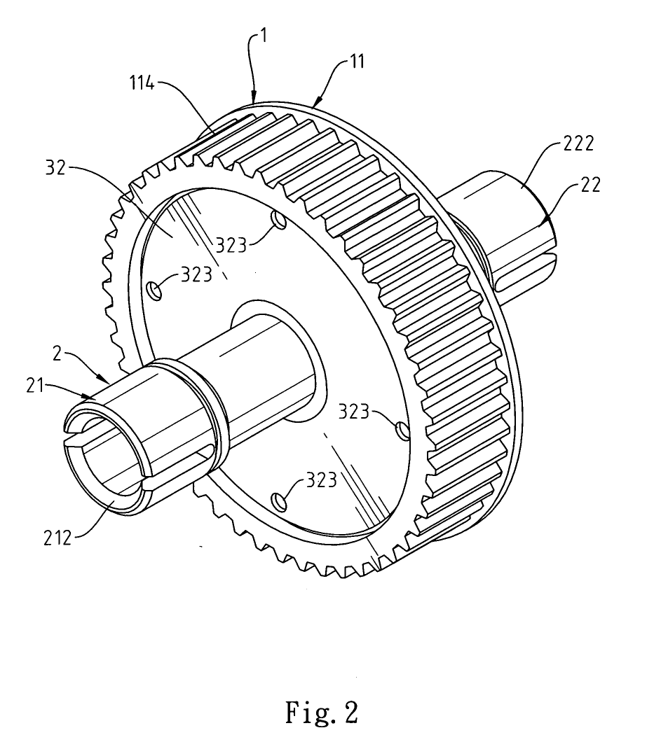

FIG. 3 is an exploded view of the differential gear for remote control toy car according to the present invention.

FIG. 4 is a cutaway view in an enlarged scale of the differential gear for remote control toy car according to the present invention.

FIG. 5 is a schematic drawing of the present invention showing a status of use of the differential gear.

### DETAILED DESCRIPTION OF THE PREFERRED EMBODIMENT

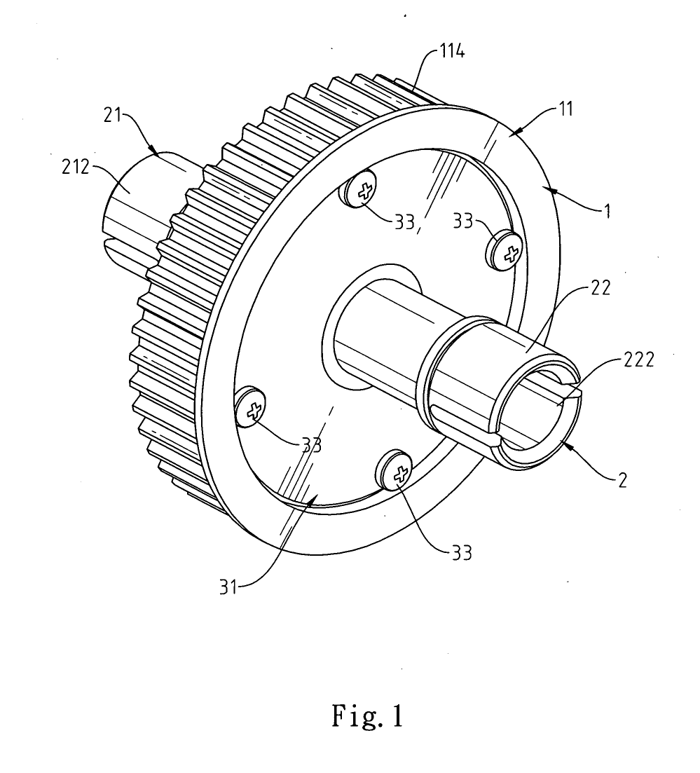

Referring to FIGS. 1˜3, a differential gear for remote control toy car in accordance with the present invention is shown comprised of a drive gear 1, a coupling device set 2, and a fixing device set 3.

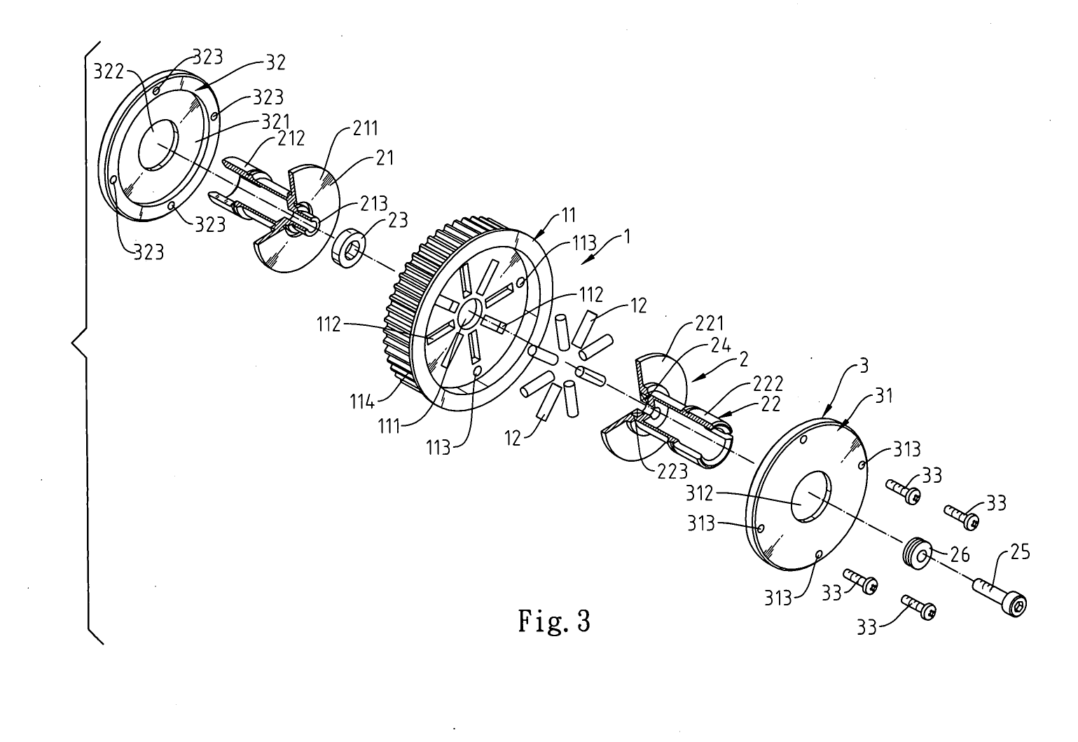

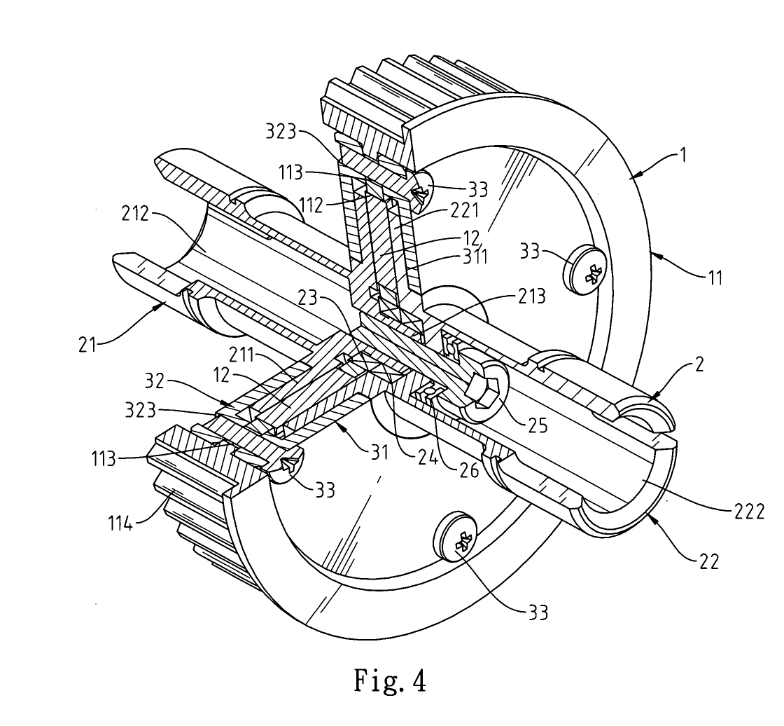

Referring to FIG. 4 and FIG. 3 again, the drive gear 1 comprises a gear wheel 11 and a plurality of needle rollers 12. The gear wheel 11 has an axle hole 111 cut through the two opposite sides at the center, a plurality of needle roller grooves 112 radially extending from the axle hole 111 for accommodating the needle rollers 12, a plurality of mounting through holes 113 cut through the two opposite sides and equiangularly spaced near the periphery, and gear teeth 114 arranged around the periphery for coupled to a power source.

Referring to FIGS. 3 and 4 again, the coupling device set 2 is movably attached to the two opposite sides of the drive gear 1, comprising a first coupling device 21, a second coupling device 22, two axle bearings 23 and 24, a fastening member 25, and a thrust bearing 26. The thrust bearing 26 is sleeved onto the fastening member 25. The first coupling device 21 and the second coupling device 22 are respectively attached to the two opposite sides of the gear wheel 11 of the drive gear 1. The first coupling device 21 has an abutment wall 211 stopped against the needle rollers 12 and disposed at one side of the gear wheel 11, a coupling tube 212 perpendicularly extending from the center of one side of the abutment wall 211 opposite to the gear wheel 11, and a stub axle 213 perpendicularly extending from the center of the other side of the abutment wall 211 and inserted into the axle hole 111 of the gear wheel 11 and coupled to the second coupling device 22 by the fastening member 25. One axle bearing 23 is sleeved onto the stub axle 213 and stopped between the abutment wall 211 and the corresponding side of the gear wheel 11.

The second coupling device 22 has an abutment wall 221 stopped against the needle rollers 12 and disposed at the other side of the gear wheel 11, a coupling tube 222 perpendicularly extending from the center of one side of the abutment wall 221 opposite to the gear wheel 11, and a recessed coupling hole 223 disposed at the center of the other side of the abutment wall 211 and coupled to the stub axle 213 of the first coupling device 21 by the fastening member 25 and the thrust bearing 26 for allowing free rotation of the first coupling device 21 relative to the second coupling device 22. The other axle bearing 24 is sleeved onto the stub axle 213 and accommodated in the recessed coupling hole 223 and stopped between the abutment wall 221 and the corresponding side of the gear wheel 11.

The abutment wall 211 and needle rollers 12 are made of a wear resistant material. Further, when the abutment wall 211 is rotated with the first coupling device 21 through one turn, the needle rollers 12 are rotated through a number of turns. On design, the needle rollers 12 has a hardness greater than the abutment wall 211, i.e., the needle rollers 12 has better wear resistance than the abutment wall 211.

Referring to FIGS. 3 and 4 again, the fixing device set 3 is secured to two opposite sides of the coupling device set 2. The fixing device set 3 comprises a first dust cover 31, a second dust cover 32, and a plurality of fastening members 33. The first dust cover 31 has a recessed chamber 311 disposed at one side for accommodating the abutment wall 211 of the first coupling device 21, a center through hole 312 cut through the two opposite sides at the center for the passing of the coupling tube 212 of the second coupling device 21, and a plurality of mounting through holes 313 cut through the two opposite sides and equiangularly spaced around the center through hole 312 corresponding to the mounting through holes 113 of the gear wheel 11. The second dust cover 32 has a recessed chamber 321 disposed at one side for accommodating the abutment wall 221 of the second coupling device 22, a center through hole 322 cut through the two opposite sides at the center for the passing of the coupling tube 222 of the second coupling device 22, and a plurality of mounting through holes 323 cut through the two opposite sides and equiangularly spaced around the center through hole 322 corresponding to the mounting through holes 113 of the gear wheel 11. The fastening members 33 are respectively fastened to the mounting through holes 313 of the first dust cover 31 and the mounting through holes 323 of the second dust cover 32 to secure the first dust cover 31 and the second dust cover 32 to the two opposite sides of the gear wheel 11 of the drive gear 1. By means of controlling the fastening tightness of the fastening members 25 to adjust the friction resistance between the first coupling device 21 and the needle rollers 12 and the friction resistance between the second coupling device 22 and the needle rollers 12, the differential ratio is relatively adjusted.

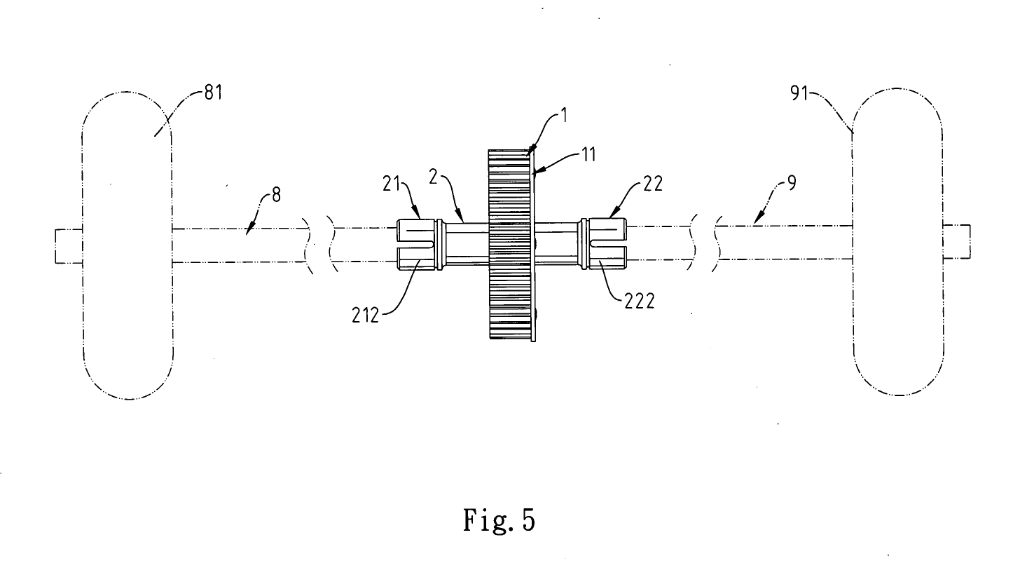

Referring to FIG. 5 and FIG. 4 again, when in use, the teeth 114 of the gear wheel 11 is coupled to the power source (not shown), the coupling tube 212 of the first coupling device 21 is coupled to a first wheel shaft 8 carrying a first wheel 81, and the coupling tube 222 of the second coupling device 22 is coupled to a second wheel shaft 9 caring a second wheel 91. Because the needle rollers 12 are stopped between the first coupling device 21 and the second coupling device 22, rotating the drive gear 1 by the power source causes a friction resistance between the gear wheel 11 and the coupling devices 21 and 22, and therefore the coupling devices 21 and 22 rotated. During rotation of the coupling devices 21 and 22, the wheel shafts 8 and 9 are rotated, and therefore the wheels 81 and 91 are rotated.

When the wheel shafts 8 and 9 are giving an axial thrust force to the drive gear 1 and the coupling device 2 in a curve driving, the wheel at the inner side of the turn is caused to lower the speed, thereby reducing the radius of turn and smoothening the curve driving.

Although a particular embodiment of the invention has been described in detail for purposes of illustration, various modifications and enhancements may be made without departing from the spirit and scope of the invention.

What the invention claimed is:

1. A differential gear for use in a remote control toy car, comprising:
a drive gear, said drive gear comprising a gear wheel, said gear wheel having a center axle hole, and a plurality of needle rollers radially mounted in said gear wheel;
a first coupling device coupled to a first side of said drive gear, said first coupling device comprising an abutment wall stopped against said needle rollers and disposed at one side relative to said gear wheel, a stub axle perpendicularly extending from the center of one side of the abutment wall of said first coupling device and inserted through the center axle hole of said gear wheel, and a coupling tube perpendicularly extending from the center of an opposite side of the abutment wall of said first coupling device; and
a second coupling device coupled to a second side of said drive gear opposite to said first coupling device, said second coupling device comprising an abutment wall stopped against said needle rollers and disposed at an opposite side relative to said gear wheel, a recessed coupling hole formed on one side of the abutment wall of said second coupling device and coupled to said stub axle of said first coupling device for allowing free rotation of said second coupling device relative to said first coupling device, and a coupling tube perpendicularly extending from the center of an opposite side of the abutment wall of said second coupling device.

2. The differential gear as claimed in claim 1, wherein said gear wheel comprises a plurality of equiangularly mounting through holes for the mounting of fastening members to secure two dust covers to two opposite sides of said gear wheel.

3. The differential gear as claimed in claim 1, further comprising a first axle bearing sleeved onto said stub axle of said first coupling device and stopped between one side of said gear wheel and the abutment wall of said first coupling device, and a second axle bearing sleeved onto said stub axle of said first coupling device and accommodated in said recessed coupling hole of said second coupling device and stopped between an opposite side of said gear wheel and the abutment wall of said second coupling device.

4. The differential gear as claimed in claim 1, further comprising a fixing device set fastened to said gear wheel to secure said first coupling device and said second coupling device to said gear wheel.

5. The differential gear as claimed in claim 4, wherein said fixing device comprises a first dust cover fastened to one side of said gear wheel and covered over the abutment wall of said first coupling device, and a second dust cover fastened to an opposite side of said gear wheel and covered over the abutment wall of said second coupling device.
